(19) United States
(12) Patent Application Publication
(10) Pub. No.: US 2025/0121591 A1
(43) Pub. Date: Apr. 17, 2025

(54) METHODS FOR PRODUCING COMPOSITES THAT MITIGATE STRICT FAYING SURFACE TOLERANCES

(71) Applicant: United States of America as represented by the Administrator of NASA, Washington, DC (US)

(72) Inventors: Tyler B. Hudson, Suffolk, VA (US); Frank L. Palmieri, VA Beach, VA (US); Austin J. Smith, Newport News, VA (US); Jin Ho Kang, Newport News, VA (US); Roberto J. Cano, Yorktown, VA (US)

(21) Appl. No.: 18/378,914

(22) Filed: Oct. 11, 2023

(51) Int. Cl. B32B 37/18; B32B 5/02; B32B 5/26; B32B 7/12; B32B 27/08; B32B 27/12; B32B 27/38; B32B 37/12

(52) U.S. Cl. CPC B32B 37/18; B32B 5/024; B32B 5/263; B32B 7/12; B32B 27/08; B32B 27/12; B32B 27/38; B32B 37/1207; B32B 2260/023; B32B 2260/046; B32B 2262/106; B32B 2305/076; B32B 2309/02; B32B 2605/18

(57) ABSTRACT

Inherent susceptibility of adhesive bonds to even minute quantities of contamination can often cause undetectable weakened bonds. Described herein are methods for producing composites that mitigate strict faying surface tolerances. In one aspect, the methods described herein use an adhesive to alleviate the strict manufacturing tolerances of previous techniques and methodologies. The inclusion of conventional ratio adhesive as a gap filler offers the advantage of being a drop-in replacement for existing state-of-the-art adhesively bonded composite joints. In another aspect, composites are produced by co-bonding with or without an adhesive. The methods described herein can seamlessly replace current bonding methods without requiring significant modifications or changes to the manufacturing process. This compatibility and ease of implementation makes the methods described herein a promising option for enhancing composite bonding in various industries where composite materials are utilized.

### STATEMENT REGARDING FEDERALLY SPONSORED RESEARCH OR DEVELOPMENT

The invention described herein was made by employees of the United States Government and may be manufactured and used by or for the Government of the United States of America for governmental purposes without the payment of any royalties thereon or therefore.

### BACKGROUND OF THE INVENTION

Carbon fiber reinforced polymer (CFRP) primary aircraft structures have flown for over 30 years. Despite this, aircraft such as the Boeing 787 Dreamliner still fly with thousands of redundant fasteners [1] (e.g., FIG. 1A). This practice is a direct result of the Federal Aviation Administration (FAA) certification requirements for adhesively bonded aircraft structures [2]. Fasteners are employed as the most cost-effective and straightforward solution to satisfy the FAA's mandated criteria. Nevertheless, the requirement for redundant load paths in adhesively bonded joints contributes to additional challenges such as increased aircraft weight, higher costs, and longer manufacturing time. These FAA regulations stem from the inherent uncertainty associated with adhesive bonds, primarily arising from material discontinuity at the composite-to-adhesive interfaces which are prone to contamination. Quantifiable and consistent surface preparation is required to prevent contamination and ensure proper adhesion [3].

### BRIEF SUMMARY OF THE INVENTION

Inherent susceptibility of adhesive bonds to even minute quantities of contamination can often cause undetectable weakened bonds. Described herein are methods for producing composites that mitigate strict faying surface tolerances. In one aspect, the methods described herein use an adhesive to alleviate the strict manufacturing tolerances of previous techniques and methodologies. The inclusion of conventional ratio adhesive as a gap filler offers the advantage of being a drop-in replacement for existing state-of-the-art adhesively bonded composite joints. In another aspect, composites are produced by co-bonding with or without an adhesive. The methods described herein can seamlessly replace current bonding methods without requiring significant modifications or changes to the manufacturing process. This compatibility and ease of implementation makes the methods described herein a promising option for enhancing composite bonding in various industries where composite materials are utilized.

### BRIEF DESCRIPTION OF THE SEVERAL VIEWS OF THE DRAWINGS

FIG. 1A shows the current state of the art method for the composite structure bonding process. FIG. 1B shows a method described herein (AERoBOND+) for making a composite structure.

FIGS. 2-6 depict a process described herein for making the composites (AERoBOND+).

FIGS. 7A-7B depict a process for making the composites described herein by co-bonding.

FIGS. 8A-8C show (a) co-cured control panel C1 layup diagram, (b) control panels (C2-C5) layup diagram, and (c) AERoBOND+ panels (AB+1-AB+5) layup diagram. ER is an epoxy resin (i.e., hardener reactive groups or HRG referred to herein) and HR is a hardener resin (i.e., hardener groups or HG referred to herein).

FIGS. 9A-9J show the maximum ultrasonic amplitude from the joint line within panels (a) C1, (b) C2, (c) C3, (d) C4, (e) C5, (f) AB+1, (g) AB+2, (h) AB+3, (i) AB+4, and (j) AB+5.

FIG. 10 shows the average maximum joint line amplitudes between crack starters from ultrasonic inspection wherein higher amplitudes indicate material discontinuity at the interface.

FIG. 11 shows the mode-I interlaminar fracture toughness properties from DCB tests of the adhesive to prepreg interface.

FIG. 12 shows the non-precracked mode-II interlaminar fracture toughness properties from ENF tests of the adhesive to prepreg interface.

FIG. 13 shows the precracked mode-II interlaminar fracture toughness properties from ENF tests of the adhesive to prepreg interface.

FIG. 14 shows the mode-I interlaminar fracture toughness properties from DCB tests of the prepreg to prepreg interface.

FIG. 15 shows the non-precracked mode-II interlaminar fracture toughness properties from ENF tests of the prepreg to prepreg interface.

FIG. 16 shows the precracked mode-II interlaminar fracture toughness properties from ENF tests of the prepreg to prepreg interface.

FIG. 17 shows the mean short beam strength properties from SBS tests.

FIG. 18 shows the panel C5 SBS test indicating failure in IM7/8552 prepreg interface.

### DETAILED DESCRIPTION OF THE INVENTION

Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.”

As used in the specification and the appended claims, the singular forms “a,” “an” and “the” include plural referents unless the context clearly dictates otherwise. Thus, for example, reference to “a solvent” include, but are not limited to, mixtures or combinations of two or more such solvents, and the like.

Identifiers such as “first curable resin” and “second curable resin” are provided herein and are used to distinguish different components.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g., the phrase “x to y” includes the range from ‘x’ to ‘y’ as well as the range greater than ‘x’ and less than ‘y’. The range can also be expressed as an upper limit, e.g., ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

Disclosed are the components to be used to conduct the methods of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific embodiment or combination of embodiments of the methods of the invention.

As used herein, the terms “optional” or “optionally” means that the subsequently described event or circumstance can or cannot occur, and that the description includes instances where said event or circumstance occurs and instances where it does not.

As used herein, the terms “cure” and “curing” encompass polymerizing and/or crosslinking of a resin or polymeric material brought about by mixing of reactive based components with a functionality of two or more, heating at elevated temperatures, and/or exposing the materials to ultraviolet light and radiation.

The term a “fully cured” resin as used herein refers to when the curable no longer undergoes polymerization. As known in the art, even when using the term “fully cured” there may still regularly be some residual functional groups that have not polymerized or cross-linked due to chain end mobility or other known reasons. In some embodiments, a “fully cured” resin or composition may contain less than about 1%, about 0.1%, or about 0.01% residual reactive functional groups as determined by the molar percentage of the initial total moles of functional groups in a material.

In one aspect, the degree of cure (DOC) can be measured by differential scanning calorimetry (DSC). Differential scanning calorimetry (DSC) is used to measure the exotherm due to the enthalpy of polymerization. For example, an uncured (0% degree of cure, DoC) sample is cured in the DSC to the maximum extent of reaction attainable to measure the total heat of reaction (THR). A new sample of the same material at an unknown DoC can be placed in the DSC and put through the same cure process to measure the residual heat of reaction (RHR). The extent of cure of the unknown sample is then taken as (1−RHR/THR)×100%.

In another aspect, the (DOC) can be measured by spectroscopy. Infrared, near infrared, and Raman spectroscopy can be used to quantify the concentrations of reactive functional groups in a polymer. When a clearly discernable peak associated with a limiting functional group can be identified in the spectrum, then it is possible to directly track the consumption of that functional group (and the DoC) by collecting spectral data at various stages of cure. The peak area or peak height can be used to quantify the concentration of the functional group(s) associated with that peak(s).

The term a “partially cured” resin may contain more than about 10%, about 20%, about 30%, about 50%, about 60%, about 70%, about 80%, or about 90% residual reactive functional groups as determined by the molar percentage of the initial total moles of functional groups in the material. The term “partially cured” also refers to the point at which the curable resin is less than the gel point of the curable resin. The term “gel point” as defined herein as the DOC where the polymer first forms an infinite network, the material becomes insoluble, and the material takes on an elastic modulus. In one aspect, the gel point of the curable resin can be measured rheologically using dynamic mechanical analysis (DMA) or a torsional (e.g., parallel plate) rheometer. An oscillatory mechanical test is carried out during the resin cure process. The gel point is identified by the point where the measured storage modulus exceeds the measured loss modulus. During the dynamic testing, the material is heated according to a cure cycle (time and temperature is measured) while the storage and loss moduli are measured. Either DSC or spectral techniques are used to determine the DOC of the material due to the applied cure cycle. Once you have both the rheology and DoC measurements, the DoC at the gel point can be determined.

As used herein, the term “faying surface” is the surface or of a material or layer that interfaces with the faying surface of a second material or layer. The two layers are adjacent to (i.e., in contact with) one another at the faying surface of each layer.

As used herein, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

Unless otherwise specified, temperatures referred to herein are based on atmospheric pressure (i.e., one atmosphere).

It is to be understood that the invention may assume various alternative orientations and step sequences, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

### Methods for Producing Composites

The methods described herein use stoichiometrically offset thermoset polymers to enable reflow and diffusion of the resin at the joint interface during a secondary bonding/cure process. By promoting the intermixing of the matrix resin at the interface, material discontinuity can be eliminated. This technology uses a stoichiometric offset in the hardener-hardener reactive groups ratio on the faying surfaces of the laminates. This arrangement enables the intermixing of hardener rich and hardener reactive group resins, leading to the formation of a conventional ratio (CR) resin. As a result, the composite assembly exhibits a seamless interface without discernible material discontinuities. This approach ensures a uniform and integrated structure, enhancing the overall performance of the component and removing the dependence on adhesive-based secondary bonding. The process discussed above is referred to as AERoBOND developed by NASA.

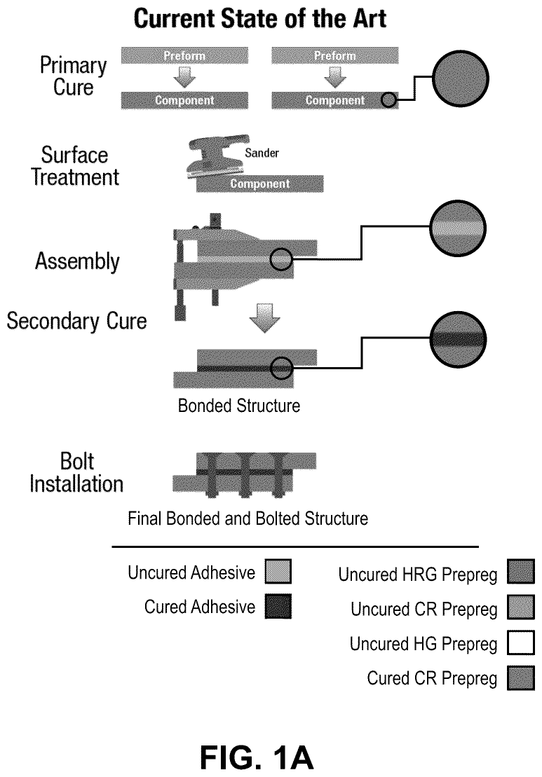

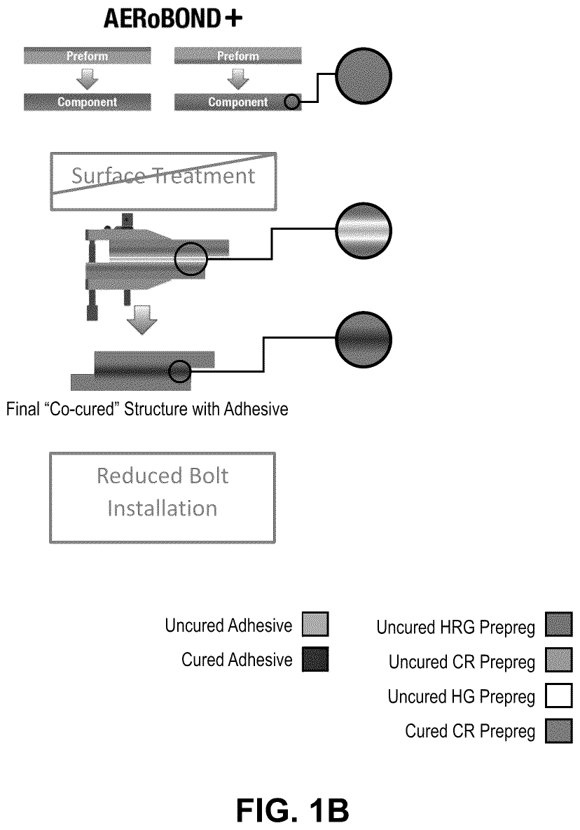

However, the AERoBOND process required tight spatial tolerances between the two parts being joined. The methods described herein address this issue with the use of an adhesive. The inclusion of conventional ratio adhesive as a gap filler in the methods described herein (also referred to as AERoBOND+ as depicted in FIG. 1B) offers the advantage of being a drop-in replacement for existing state-of-the-art adhesively bonded composite joints. This means that AERoBOND+ can seamlessly replace current bonding methods without requiring significant modifications or changes to the manufacturing process. This compatibility and ease of implementation makes AERoBOND+ a promising option for enhancing composite bonding in various industries where composite materials are utilized.

Described herein are methods for producing composites that mitigate strict faying surface tolerances. In one aspect, the methods described herein use an adhesive to alleviate the strict manufacturing tolerances of previous techniques and methodologies. Thus, composite surfaces with the slightest amount of impurities or imperfections can be used in the methods described herein to produce seamless bonds and interfaces without the need for surface preparation (e.g., sanding) of any faying surface.

In one aspect, a method for producing a composite comprising:
(a) providing a first composite substrate and a second composite substrate, wherein the first composite substrate and the second composite substrate each comprises a substrate with a faying surface comprising a first curable resin comprising a first stoichiometrically offset thermoset polymer, wherein the first stoichiometrically offset thermoset polymer is stoichiometrically offset with hardener reactive groups;
   wherein the first composite substrate and/or the second composite substrate are cured such that hardener reactive groups remain on the faying surface of the composite substrate after cure;
(b) applying a second stoichiometrically offset thermoset polymer to the faying surface of the first composite substrate and the second composite substrate to produce a first stack and a second stack, wherein the second stoichiometrically offset thermoset polymer is stoichiometrically offset with hardener groups, and
   wherein the molar ratio of the hardener reactive groups of the first stoichiometrically offset thermoset polymer and the hardener groups of the second stoichiometrically offset thermoset polymer is from about 0.6 to about 1.2 after diffusion during cure;
(c) applying a first adhesive to the faying surface of the first stack, the faying surface of the second stack, or on both the faying surface of the first stack and the faying surface of the second stack to produce a third stack and fourth stack, wherein the first adhesive has a curing temperature within 25° C. of the curing temperature of the first curable resin on the first composite substrate and a second composite substrate;
(d) coupling the third stack with the fourth stack, wherein the first adhesive is between the second stoichiometrically offset thermoset polymer on the third stack and the fourth stack to produce a fifth stack; and
(e) curing the fifth stack to produce the composite.

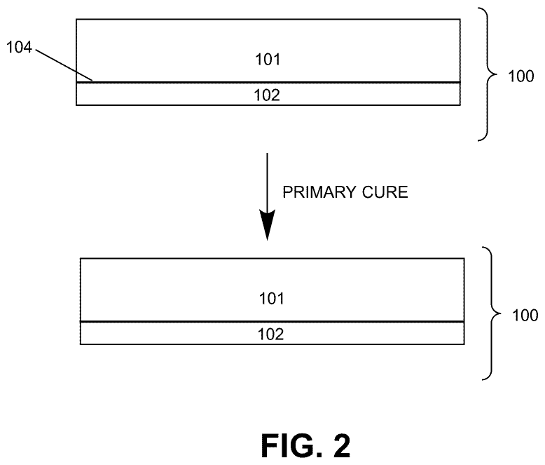

Referring to FIG. 2, the first composite substrate and the second composite substrate 100 are each composed of (i) a substrate 101 comprising a first curable resin 102. The first and second composite substrates are independently assembled. The first and second substrate each include a first curable resin comprising a first stoichiometrically offset thermoset polymer, wherein the first stoichiometrically offset thermoset polymer is stoichiometrically offset with hardener reactive groups. The first curable resin is on the first faying surface 104 of the first composite substrate and the second composite substrate.

In another aspect, the substrate in the first and second composite substrate can be individually composed of a curable resin (i.e., stoichiometrically offset thermoset polymer) with non-reinforcing carrier fibers (e.g., non-woven polyester carrier mat). In another aspect, the substrate used to produce the first and second composite substrates can be individual prepregs that can be laid upon one another using techniques known in the art to produce the precursor to the first and second composite substrates. The term “prepreg” as defined herein, refers to a layer of fibrous material (e.g., fibers, unidirectional fibers, unidirectional tows or tape, non-woven mat, and/or fabric ply) that has been impregnated with a curable resin as described herein. Prepregs may be manufactured by infusing or impregnating continuous fibers or woven fabric with a curable resin, creating a pliable and tacky sheet of material. This infusion or impregnation is often referred to as a prepregging process. The precise specification of the fibers, their orientation and the formulation of the resin matrix can be specified to achieve the optimum performance for the intended use of the prepregs. The volume of fibers per square meter can also be specified according to requirements. The fiber reinforcement material may be in the form of a woven or nonwoven fabric ply, or continuous unidirectional fibers. The term “unidirectional fibers” as used herein, refers to a layer of reinforcement fibers that are aligned in the same direction.

In one aspect, the reinforcement fibers in the prepregs may take the form of chopped fibers, continuous fibers, filaments, tows, bundles, sheets, plies, and combinations thereof. Continuous fibers may further adopt any of unidirectional (aligned in one direction), multi-directional (aligned in different directions), non-woven, woven, knitted, stitched, wound, and braided configurations, as well as swirl mat, felt mat, and chopped mat structures. Woven fiber structures may comprise a plurality of woven tows, each tow composed of a plurality of filaments, e.g., thousands of filaments. In other aspects, the one or more reinforcement fibers may include, but are not limited to, glass (including Electrical or E-glass), carbon (including graphite), aramid, polyamide, high-modulus polyethylene (PE), polyester, poly-p-phenylene-benzoxazole (PBO), boron, quartz, basalt, ceramic, and combinations thereof.

After the first composite substrate and a second composite substrate have been individually assembled, the first composite substrate and/or the second composite substrate 100 are independently cured for a sufficient time and temperature (FIG. 2). This curing step is referred to as the primary curing step. The duration and temperature applied during the primary curing step can vary depending upon the selection of the curable resins used to produce the substrate. In one aspect, the primary curing step is conducted at a temperature of from about 25° C. to about 400° C., or about 25° C., 50° C., 75° C., 100° C., 125° C., 150° C., 175° C., 200° C., 225° C., 250° C., 275° C., 300° C., 325° C., 350° C., 375° C., or 400° C., where any value can be a lower and upper endpoint of a range (e.g., 175° C. to 250° C.).

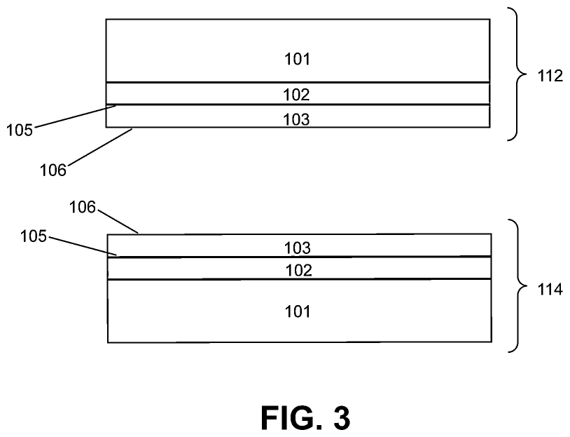

After the first and second composite substrates 100 have been independently assembled and undergone primary curing (i.e., the first composite substrate and/or the second composite substrate are independently cured), a second stoichiometrically offset thermoset polymer 103 is applied to the second faying surface 105 of the first composite substrate and the second composite substrate to produce a first stack 112 comprising a third faying surface 106 on the first composite substrate and a second stack comprising 114 a third faying surface 106 on the second composite substrate, wherein second stoichiometrically offset thermoset polymer is stoichiometrically offset with hardener groups, as depicted in FIG. 3.

In one aspect, the second stoichiometrically offset thermoset polymer 103 includes fibers. For example, the second stoichiometrically offset thermoset polymer can be included in a prepreg as described above with respect to the substrate. In this aspect, one or more prepregs with the second stoichiometrically offset thermoset polymer can be laid on the second faying surface on the first composite substrate and the second faying surface of the second composite substrate.

In another aspect, the second stoichiometrically offset thermoset polymer 103 can be applied as a neat polymer (i.e., in the absence of any reinforcing fibers) on the second faying surface of the first and second composite substrates. In this aspect, the neat second stoichiometrically offset thermoset polymer can be applied using techniques known in the art such as, for example, spraying or coating the second stoichiometrically offset thermoset polymer on the second faying surface.

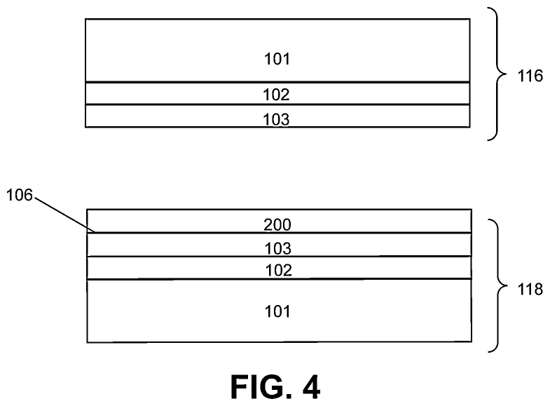

After the second stoichiometrically offset thermoset polymer 103 has been applied to the second faying surface of the first composite substrate and the second composite substrate, a first adhesive 200 is applied to the third faying surface 106 of the first stack 112, the third faying surface 106 of the second stack 114, or on both the third faying surface 106 of the first stack and the third first faying surface of the second stack. FIG. 4 depicts the first adhesive applied to the third faying surface 106 of the second stack 114. In this aspect, the first adhesive can be applied using techniques known in the art such as, for example, spraying or coating the third faying surface of the first and second stack with the first adhesive.

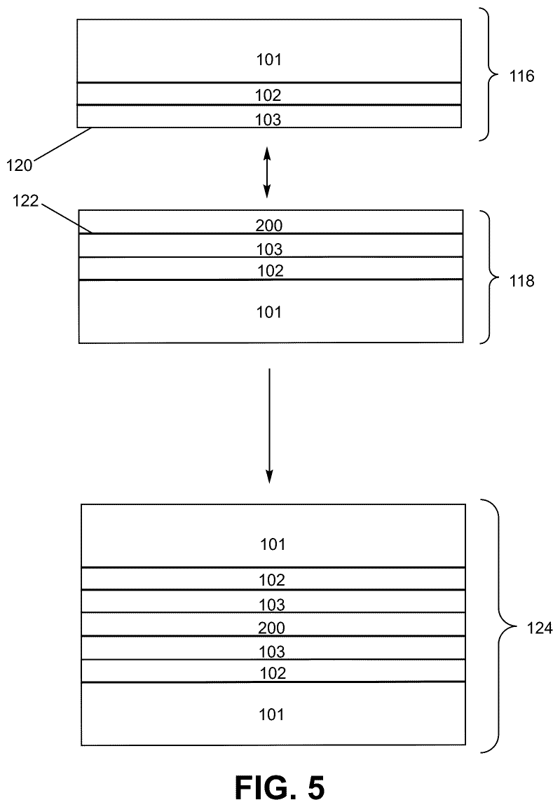

After the first adhesive has been applied, the third stack 116 is coupled with the fourth stack 118, wherein the first adhesive is between the fourth faying surface 120 of the third stack 116 and the fourth faying surface 122 of the fourth stack 118 to produce a fifth stack 124 (FIG. 5). After the coupling the third stack 116 and fourth stack 118, the first adhesive 200 is sandwiched between the two layers of the second stoichiometrically offset thermoset polymer 103.

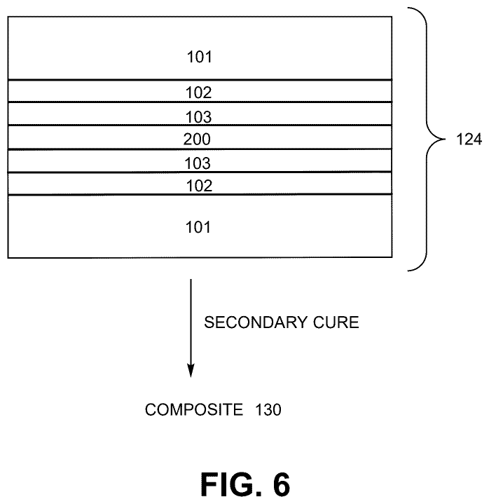

After the fifth stack 124 has been assembled, the fifth stack is cured at a sufficient time and temperature such that the first stoichiometrically offset thermoset polymer, the second stoichiometrically offset thermoset polymer, and first adhesive diffuse across the faying surfaces and are fully cured. This curing step is referred to as the secondary curing step as provided in FIG. 6. The duration and temperature applied during the secondary curing step can vary depending upon the selection of the curable resins used to produce the substrate, barrier ply, and bonding ply. In one aspect, the secondary curing step is conducted at a temperature of from about 25° C. to about 400° C., or about 25° C., 50° C., 75° C., 100° C., 125° C., 150° C., 175° C., 200° C., 225° C., 250° C., 275° C., 300° C., 325° C., 350° C., 375° C., or 400° C., where any value can be a lower and upper endpoint of a range (e.g., 175° C. to 250° C.). After secondary curing is complete, the composite 130 is produced.

FIGS. 2-5 depict the preparation of a composite with the configuration HRG/HG/ADH/HG/HRG, where HRG is hardener reactive groups, HG is hardener groups, and ADH is the adhesive. However, the reverse configuration can be prepared using the same methods as described above by switching the first and second stoichiometrically offset thermoset polymers to produce the configuration HG/HRG/ADH/HRG/HG. In one aspect, the method comprises
(a) providing a first composite substrate and a second composite substrate, wherein the first composite substrate and the second composite substrate each comprises a substrate with a faying surface comprising a first curable resin comprising a first stoichiometrically offset thermoset polymer, wherein the first stoichiometrically offset thermoset polymer is stoichiometrically offset with hardener groups;
   wherein the first composite substrate and/or the second composite substrate are cured such that hardener groups remain on the faying surface of the composite substrate after cure;
(b) applying a second stoichiometrically offset thermoset polymer to the faying surface of the first composite substrate and the second composite substrate to produce a first stack and a second stack, wherein second stoichiometrically offset thermoset polymer, wherein the second stoichiometrically offset thermoset polymer is stoichiometrically offset with hardener reactive groups, and
   wherein the molar ratio of the hardener reactive groups of the first stoichiometrically offset thermoset polymer and the hardener groups of the second stoichiometrically offset thermoset polymer is from about 0.6 to about 1.2 after diffusion during cure;
(c) applying a first adhesive to the third faying surface of the first stack, the third faying surface of the second stack, or on both the third faying surface of the first stack and the third first faying surface of the second stack to produce a third stack and fourth stack, wherein the first adhesive has a curing temperature within 25° C. of the curing temperature of the first curable resin on the first composite substrate and a second composite substrate;
(d) coupling the third stack with the fourth stack, wherein the first adhesive is between the second stoichiometrically offset thermoset polymer on the third stack and the fourth stack to produce a fifth stack; and
(e) curing the fifth stack to produce the composite.

In another aspect, the composite can be produced by the method comprising:
(a) providing a first composite substrate, wherein the first composite substrate comprises a substrate with a faying surface comprising a first curable resin comprising a first stoichiometrically offset thermoset polymer, wherein the first stoichiometrically offset thermoset polymer is stoichiometrically offset with hardener reactive groups, wherein the first curable resin has a second faying surface, and wherein the first composite substrate is cured;
(b) providing a second composite substrate, wherein the second composite substrate comprises a substrate comprising a first faying surface
(c) applying a second stoichiometrically offset thermoset polymer to the second faying surface of the first composite substrate, wherein second stoichiometrically offset thermoset polymer is stoichiometrically offset with hardener groups to produce a first stack, and
   wherein the molar ratio of the hardener reactive groups of the first stoichiometrically offset thermoset polymer and the hardener groups of the second stoichiometrically offset thermoset polymer is from about 0.6 to about 1.2 after diffusion during cure;
(d) coupling the first stack with the second composite substrate, wherein the second stoichiometrically offset thermoset polymer is in contact with the first faying surface of the second composite substrate to produce a second stack; and
(e) curing the second stack to produce the composite.

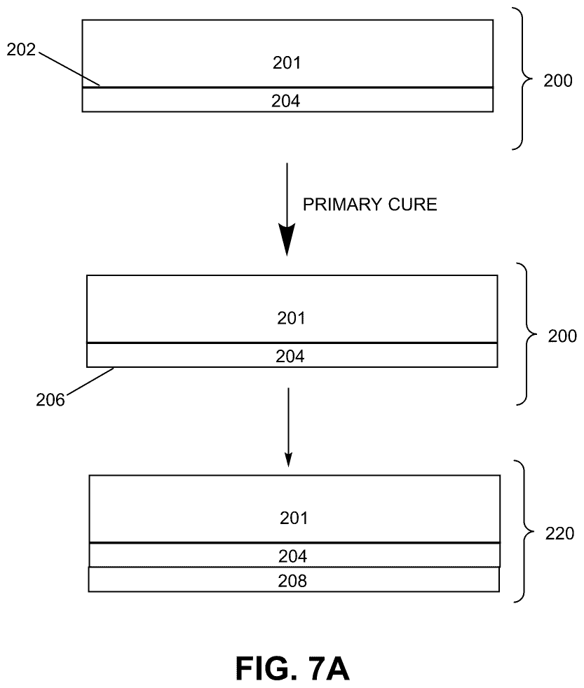

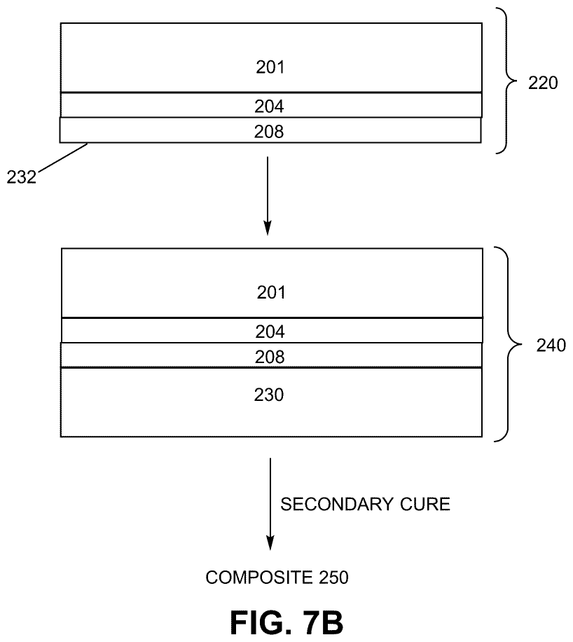

This method is referred to as co-bonding. Referring to FIGS. 7A-7B, a first composite substrate 200 includes a substrate 201 with a first faying surface 202 comprising a first curable resin comprising a first stoichiometrically offset thermoset polymer 204. The first composite substrate 200 undergoes a primary cure to produce the first composite substrate with a second faying surface 206.

Next, a second stoichiometrically offset thermoset polymer 208 is applied to the second faying surface 206 of the first composite substrate 200, wherein second stoichiometrically offset thermoset polymer is stoichiometrically offset with hardener groups to produce a first stack 220. The first stack 220 is coupled with the second composite substrate 230, wherein the second stoichiometrically offset thermoset polymer 208 is in contact with the first faying surface 232 of the second composite substrate 230 to produce a second stack 240.

After the second stack 240 has been assembled, the second stack is cured at a sufficient time and temperature such that the first stoichiometrically offset thermoset polymer and the second stoichiometrically offset thermoset polymer diffuse across the faying surface 206 are fully cured (i.e., secondary curing) to produce the final composite 250.

### Stoichiometrically Offset Thermoset Polymers

As discussed above, the methods described herein use stoichiometrically offset thermoset polymers to enable reflow and diffusion of the resin at the joint interface during a secondary bonding/cure process. By promoting the intermixing of the matrix resin at the interface, material discontinuity can be eliminated. This technology uses a stoichiometric offset in the hardener-hardener reactive groups ratio on the faying surfaces of the laminates. This arrangement enables the intermixing of hardener rich and hardener reactive group resins, leading to the formation of a conventional ratio (CR) resin.

In one aspect, the stoichiometrically offset thermoset polymer is stoichiometrically offset with hardener reactive groups or hardener groups. The stoichiometric offset (r) is defined by equation (1):

$$r = \frac{{eq}_{H}}{{eq}_{HR}} ≡ \frac{molar equivalents of hardener groups}{molar equivalents of hardener reactive groups} \qquad ( 1 )$$

Thus, a stoichiometrically offset thermoset polymer offset with hardener reactive groups will have an offset (r) of less than 1, where the molar equivalents of the hardener reactive groups is greater than the molar equivalents of the hardener groups. In one aspect, the first stoichiometrically offset thermoset polymer has a stoichiometric offset of from about 0.01 to about 0.20, or 0.01, 0.02, 0.04, 0.06, 0.08, 0.10, 0.12, 0.14, 0.16, 0.18, or 0.20, where any value can be a lower and upper endpoint of a range (e.g., 0.06 to 0.10).

A stoichiometrically offset thermoset polymer offset with hardener groups will have an offset (r) of greater than 1, where the molar equivalents of the hardener groups is greater than the molar equivalents of the hardener reactive groups. In one aspect, the first stoichiometrically offset thermoset polymer has a stoichiometric offset of from about 1.50 to about 10.00, or 1.50, 1.75, 2.00, 2.25, 2.50, 2.75, 3.00, 3.25, 3.50, 3.75, 4.00, 5.00, 6.00, 7.00, 8.00, 9.00, or 10.00, where any value can be a lower and upper endpoint of a range (e.g., 2.00 to 3.00).

The molar ratio of the hardener reactive groups of the first stoichiometrically offset thermoset polymer and the hardener groups of the second stoichiometrically offset thermoset polymer is from about 0.6 to about 1.2 when cured, or 0.6, 0.7, 0.8, 0.9, 1.0, 1.1, or 1.2, where any value can be a lower and upper endpoint of a range (e.g., 0.7 to 0.9). As will be discussed in greater detail below, the composites produced herein will ultimately be composed of a conventional ratio resin after curing. Thus, depending upon the amount of stoichiometrically offset in the first and second stoichiometrically offset thermoset polymer, the molar ratio of hardener groups and hardener reactive groups can be modified so that the final composite is a conventional ratio resin after curing.

In one aspect, the stoichiometrically offset thermoset polymer is stoichiometrically offset with hardener reactive groups is a multifunctional epoxy resin (or polyepoxide) having a plurality of epoxide functional groups per molecule. The polyepoxide may be saturated, unsaturated, cyclic, or acyclic, aliphatic, aromatic, or hetero-cyclic polyepoxide compounds. Examples of suitable polyepoxides include the polyglycidyl ethers, which are prepared by reaction of epichlorohydrin or epibromohydrin with a polyphenol in the presence of alkali. Suitable polyphenols therefore are, for example, resorcinol, pyrocatechol, hydroquinone, bisphenol A (bis(4-hydroxyphenyl)-2,2-propane), bisphenol F (bis(4-hydroxyphenyl)-methane), fluorine 4,4′-dihydroxy benzophenone, bisphenol Z (4,4′-cyclohexy-lidene-bisphenol) and 1,5-hyroxynaphthalene.

In one aspect, the stoichiometrically offset thermoset polymer offset with hardener reactive groups is diglycidyl ethers of bisphenol A or bisphenol F (e.g., EPON™ 828 liquid epoxy resin), DER 331, DER 661 (solid epoxy resins) available from Dow Chemical Co.; triglycidyl ethers of aminophenol (e.g., AR ALDITE® MY 0510, MY 0500, MY 0600, MY 0610 from Huntsman Corp.). Additional examples include phenol-based novolac epoxy resins, commercially available as DEN 428, DEN 431, DEN 438, DEN 439, and DEN 485 from Dow Chemical Co.; cresol-based novolac epoxy resins commercially available as ECN 1235, ECN 1273, and ECN 1299 from Ciba-Geigy Corp.; hydrocarbon novolac epoxy resins commercially available as TACTIX® 71756, TACTIX®556, and TACTIX®756 from Huntsman Corp. In some embodiments, the epoxy resin may be DER 331, which is the reaction product of epichlorohydrin and bisphenol A. The tradename DER 331 is also commonly known as bisphenol A diglycidyl ether or 2,2′-(((propane-2,2-diylbis(4,1-phenylene))bis(oxy))bis(methylene))bis(oxirane).

In one aspect, the stoichiometrically offset thermoset polymer offset with hardener reactive groups is a tetrafunctional epoxy such as 4,4′-methylenebis(N,N-diglycidylaniline) or a trifunctional epoxy such as N,N-diglycidyl-4-glycidyloxyaniline supplied by Kaneka North America. In another aspect, the stoichiometrically offset thermoset polymer offset with hardener reactive groups is a mixture of 4,4′-methylenebis(N,N-diglycidylaniline) and N,N-diglycidyl-4-glycidyloxyaniline. In another aspect, the stoichiometrically offset thermoset polymer offset with hardener reactive group is API-60® (part A) epoxy resin supplied by Kaneka North America® with an epoxy equivalent weight of about 131 g/mol.

In one aspect, the stoichiometrically offset thermoset polymer is a hardener. The hardener contains functional groups that readily react with the stoichiometrically offset thermoset polymer offset with hardener reactive groups (e.g., epoxy groups) to produce highly cross-linked networks resulting in a fully cured composite structure. One common functional group used as a hardener is primary amines. Primary amines are functional groups with a H₂N—. Amines suitable for use as described herein include but are not limited to 4,6-diethyl-2-methylbenzene-1,3-diamine (ethacure 100), benzene-1,2-diamine (ortho-phenylenediamine), benzene-1,3-diamine (meta-phenylenediamine), benzene-1,4-diamine (para-phenylenediamine), benzidine, 2,5-diaminotoluene, diethyltoluenediamine, or any combination thereof. In one aspect, stoichiometrically offset thermoset polymer offset with hardener groups diethyltoluenediamine (DETDA) hardener supplied by Alpha Chemistry®.

In one aspect, the stoichiometrically offset thermoset polymer a thermoset resin such as, for example, phenolics, cyanate esters, polyimides, bismaleimides, polyesters, polyurethane, benzoxazines (including polybenzoxazines), amines, alcohols, and combinations thereof.

### Adhesive

As discussed above, upon curing the stoichiometrically offset thermoset polymers, intermixing of hardener rich and hardener reactive group resins occurs to produce a conventional ratio resin. The adhesive used herein includes a conventional ratio (CR) resin such that the final composite produced by the methods described herein is composed of a conventional ratio resin throughout the composite. Referring to equation (1) above, the conventional ratio resin has an r value of about 0.7 to about 1.0, or 0.7, 0.75, 0.8, 0.85, 0.9, 0.95, or 1.0, where any value can be a lower and upper endpoint of a range (e.g., 0.75 to 0.85).

In one aspect, the adhesive has a curing temperature within 25° C. of the curing temperature of the first curable resin on the first composite substrate and a second composite substrate. In another aspect, the adhesive has a curing temperature within ±1° C., ±5° C., ±10° C., ±15° C., ±20° C., or ±25° C. of the curing temperature of the first curable resin on the first composite substrate and a second composite substrate, where any value can be a lower and upper endpoint of a range (e.g., ±5° C. to ±15° C.).

In one aspect, the adhesive has a curing temperature of about 100° C. to about 400° C. In another aspect, the adhesive has a curing temperature of about 100° C., 125° C., 150° C., 175° C., 200° C., 225° C., 250° C., 275° C., 300° C., 325° C., 350° C., 375° C., or 400° C., where any value can be a lower and upper endpoint of a range (e.g., 150° C. to 350° C.). In one aspect, the adhesive is FM® 209-1 manufactured by Solvay.

In one aspect, the adhesive is film or paste adhesive. In another aspect, when the adhesive is applied as a film, the adhesive can be applied from 1 to 20 plies of adhesive film, or 1, 2, 3, 4, 5, 6, 7, 8, 9, 10, 11, 12, 13, 14, 15, 16, 17, 18, 19, or 20 plies, where any value can be a lower and upper endpoint of a range (e.g., 5 to 10).

The thickness of the adhesive can vary depending upon the application of the composite. In one aspect, the adhesive has a thickness of from about 5 μm to about 1000 μm, or about 5 μm, 50 μm, 100 μm, 200 μm, 300 μm, 350 μm, 400 μm, 500 μm, 600 μm, 700 μm, 800 μm, 900 μm, or 1000 μm, where any value can be a lower and upper endpoint of a range (e.g., 50 μm to 250 μm).

### Additional Agents

The stoichiometrically offset thermoset polymers and adhesive can optionally include one or more additional processing agents.

In one aspect, curing agents (or curatives) can slow the cure rate of the curable resin. The curatives may be selected from well-known curatives with reactivities that are well established. For instance, curatives for epoxy resins in order of increasing curing rate are generally classified as: polymercaptan<polyamide<aliphatic polyamine<aromatic polyamine derivatives<tertiary amine boron trifluoride complex<acid anhydride<imidazole<aromatic polyamine<cyanoguanadine<phenol novolac. This list is only a guide and overlap within classifications exists. Curatives of the surface treatment layer are generally selected from groups that are listed towards the higher end of the reaction order, whereas the composite substrate's curatives may be generally selected from groups towards the beginning of the reaction order.

Curing agents, curing catalysts, and curing accelerators known in the art such useful herein include, but are not limited to, transition metal catalysts, tertiary amines, imidazole containing compounds, and the like and combinations thereof. Examples of the tertiary amine curing catalysts include triethylamine, benzyldimethylamine, pyridine, picoline, 1,8-diazabiscyclo(5,4,0)undecene-1, dicyandiamide, and the like, and Examples of the imidazole compound include, but are not limited to 2-methylimidazole, 2-ethylimidazole, 2-undecylimidazole, 2-ethyl-4-methylimidazole, 2-phenyl-4,5-dihydroxymethylimidazole, 2-phenyl imidazole, phosphonium salts like tetraphenyl phosphonium phenolate and ethyltriphenyl phosphonium bromide, tetrabutyl ammonium, 4-dimethylaminopyridine, and boron trifluoride-ethylamine complex and the like.

Some non-limiting examples of curatives that may be used include, but are not limited to, melamine and substituted melamine derivatives, aliphatic and aromatic primary amines, aliphatic and aromatic tertiary amines, boron trifluoride complexes, guanidines, dicyandiamide, bisureas (including 2,4-toluene bis-(dimethyl urea), commercially available as CA 150 from CVC Thermoset Specialties), 4,4′-Methylene bis-(phenyl dimethylurea), e.g., CA 152 from CVC Thermo-set Specialties), 4,4′-diaminodiphenylsulfone (4,4-DDS), and combinations thereof.

Cure inhibitors are molecules that slow the rate of reaction between the curable resins and curatives. Examples of suitable cure inhibitors include, but are not limited to, boric acid, trifluoroborane, and derivatives thereof such as alkyl borate, alkyl borane, trimethoxyboroxine and organic acids having a pKa from 1 to 3 such as maleic acid, salicyclic acid, oxalic acid and mixtures thereof. Other inhibitors include metal oxides, metal hydroxides, and alkoxides of metal, where the metal is zinc, tin, titanium, cobalt, manganese, iron, silicon, boron, or aluminum. When such inhibitor is used, the amount of inhibitor may be up to about 15 parts per hundred parts of resin or PHR, for example, about 1 to about 5 PHR, in a resin composition. “PHR” is based on the total weight of all resins in the resin composition.

Catalysts facilitate the polymerization and crosslinking reactions of the curable resins. Some examples of suitable catalysts include compounds containing amine, phosphine, heterocyclic nitrogen, ammonium, phosphonium, arsenium, or sulfonium moieties. In other embodiments, heterocyclic nitrogen-containing and amine-containing compounds may be used such as, for example, imidazoles, imidazolidines, imidazolines, benzimidazoles, oxazoles, pyrroles, thiazoles, pyridines, pyrazines, morpholines, pyridazines, pyrimidines, pyrrolidines, pyrazoles, quinoxalines, quinazolines, phthalozines, quinolines, purines, indazoles, indoles, indolazines, phenazines, phenarsazines, phenothiazines, pyrrolines, indolines, piperidines, piperazines, and combinations thereof. When such catalysts are used, the amount of catalyst(s) may be up to about 15 parts per hundred parts of resin or PHR, for example, about 1 to about 5 PHR, in a resin composition.

The amount of the curing catalyst may be any amount that is effective for use as a catalyst and can, generally, be from about 0.01 wt. % to about 20 wt. % based on the weight of the total composition. In some embodiments, the amount of curing catalyst may be, about 0.1 wt. % to about 15 wt. %, about 0.5 wt. % to about 10 wt. %, about 1.0 wt. % to about 5 wt. %, or any range or individual concentration encompassed by these example ranges.

Inorganic fillers in particulate form (e.g., powder) may also be added to the curable resins as a rheology modifying component to control the flow of the resin composition and to prevent agglomeration therein. Suitable inorganic fillers include, but are not limited to, fumed silica, talc, mica, calcium carbonate, alumina, ground or precipitated chalks, quartz powder, zinc oxide, calcium oxide, and titanium dioxide. If present, the amount of fillers in the resin composition may range from about 0.5% to about 40% by weight, or about 1% to about 10% by weight, or about 1% to about 5% by weight, based on the total weight of the resin composition.

Organic fillers may also be added to the curable resins in order to modify the mixing and flow of the resin. In one aspect, the organic filler can possess functional groups that react with the curable resin. For example, the organic filler can be a thermoplastic polymer with functional groups (e.g., amine groups) incorporated in the polymer backbone and/or pendant to the polymer backbone that can react with functional groups (e.g., epoxy groups) in the curable resin.

### Aspects

Aspect 1. A method for producing a composite comprising:
(a) providing a first composite substrate and a second composite substrate, wherein the first composite substrate and the second composite substrate each comprises a substrate with a faying surface comprising a first curable resin comprising a first stoichiometrically offset thermoset polymer, wherein the first stoichiometrically offset thermoset polymer is stoichiometrically offset with hardener reactive groups;
   wherein the first composite substrate and/or the second composite substrate are cured such that hardener reactive groups remain on the faying surface of the composite substrate after cure;
(b) applying a second stoichiometrically offset thermoset polymer to the faying surface of the first composite substrate and the second composite substrate to produce a first stack and a second stack, wherein the second stoichiometrically offset thermoset polymer is stoichiometrically offset with hardener groups, and
   wherein the molar ratio of the hardener reactive groups of the first stoichiometrically offset thermoset polymer and the hardener groups of the second stoichiometrically offset thermoset polymer is from about 0.6 to about 1.2 after cure;
(c) applying a first adhesive to the faying surface of the first stack, the faying surface of the second stack, or on both the faying surface of the first stack and the faying surface of the second stack to produce a third stack and fourth stack, wherein the first adhesive has a curing temperature within 25° C. of the curing temperature of the first curable resin on the first composite substrate and a second composite substrate;
(d) coupling the third stack with the fourth stack, wherein the first adhesive is between the second stoichiometrically offset thermoset polymer on the third stack and the fourth stack to produce a fifth stack; and
(e) curing the fifth stack to produce the composite.

Aspect 2. The method of Aspect 1, wherein the first composite substrate and the second composite substrate comprises reinforcement fibers impregnated with the first curable resin.

Aspect 3. The method of Aspect 2, wherein the reinforcement fibers comprise carbon fibers, glass fibers, and/or para-aramid synthetic fiber.

Aspect 4. The method of Aspect 1, wherein the first stoichiometrically offset thermoset polymer comprises an epoxide resin, a bismaleimides resin, or an isocyanate resin.

Aspect 5. The method of Aspect 4, wherein the epoxide resin is reaction of epichlorohydrin or epibromohydrin with a polyphenol.

Aspect 6. The method of Aspect 4, wherein the epoxide resin is a diglycidyl ether of bisphenol A or bisphenol F, a tetraglycidyl methylenedianiline, or a diglycidylaminophenyl glycidyl ether.

Aspect 7. The method of Aspect 1, wherein the first stoichiometrically offset thermoset polymer has a stoichiometric offset of from about 0.01 to about 0.20, wherein the stoichiometric offset is the molar equivalents of the hardener groups divided by the molar equivalents of the hardener reactive groups in the first stoichiometrically offset thermoset polymer.

Aspect 8. The method of Aspect 1, wherein the second stoichiometrically offset thermoset polymer comprises reinforcement fibers impregnated with the second stoichiometrically offset thermoset polymer.

Aspect 9. The method of Aspect 8, wherein the reinforcement fibers comprise carbon fibers, glass fibers, and/or para-aramid synthetic fiber.

Aspect 10. The method of Aspect 1, wherein step (b) consists of applying only the second stoichiometrically offset thermoset polymer to the first faying surface of the first composite substrate and the second composite substrate.

Aspect 11. The method of Aspect 1, wherein the second stoichiometrically offset thermoset polymer comprises an amine.

Aspect 12. The method of Aspect 1, wherein the second stoichiometrically offset thermoset polymer has a stoichiometric offset of about 1.50 to about 10.00, wherein the stoichiometric offset is the molar equivalents of the hardener groups divided by the molar equivalents of the hardener reactive groups in the second stoichiometrically offset thermoset polymer.

Aspect 13. The method of Aspect 1, wherein the first adhesive has a curing temperature of about 100° C. to about 400° C.

Aspect 14. The method of Aspect 1, wherein the first adhesive comprises a conventional resin.

Aspect 15. The method of Aspect 1, wherein the first adhesive is film or paste adhesive.

Aspect 16. The method of Aspect 1, wherein when the first adhesive is a film, the first adhesive is applied in an amount of 1 to 20 plies of adhesive film.

Aspect 17. The method of Aspect 1, wherein the method does not include surface preparation.

Aspect 18. A method for producing a composite comprising:
(a) providing a first composite substrate and a second composite substrate, wherein the first composite substrate and the second composite substrate each comprises a substrate with a faying surface comprising a first curable resin comprising a first stoichiometrically offset thermoset polymer, wherein the first stoichiometrically offset thermoset polymer is stoichiometrically offset with hardener groups;
   wherein the first composite substrate and/or the second composite substrate are cured such that hardener groups remain on the faying surface of the composite substrate after cure;
(b) applying a second stoichiometrically offset thermoset polymer to the faying surface of the first composite substrate and the second composite substrate to produce a first stack and a second stack, wherein the second stoichiometrically offset thermoset polymer is stoichiometrically offset with hardener reactive groups, and
   wherein the molar ratio of the hardener groups of the first stoichiometrically offset thermoset polymer and the hardener reactive groups of the second stoichiometrically offset thermoset polymer is from about 0.6 to about 1.2 after cure;
(c) applying a first adhesive to the third faying surface of the first stack, the third faying surface of the second stack, or on both the third faying surface of the first stack and the third first faying surface of the second stack to produce a third stack and fourth stack, wherein the first adhesive has a curing temperature within 25° C. of the curing temperature of the first curable resin on the first composite substrate and a second composite substrate;
(d) coupling the third stack with the fourth stack, wherein the first adhesive is between the second stoichiometrically offset thermoset polymer on the third stack and the fourth stack to produce a fifth stack; and
(e) curing the fifth stack to produce the composite.

Aspect 19. The method of Aspect 18, wherein the first composite substrate and the second composite substrate comprises reinforcement fibers impregnated with the first curable resin.

Aspect 20. The method of Aspect 19, wherein the reinforcement fibers comprise carbon fibers, glass fibers, and/or para-aramid synthetic fiber.

Aspect 21. The method of Aspect 18, wherein the second stoichiometrically offset thermoset polymer comprises an epoxide resin, a bismaleimides resin, or an isocyanate resin.

Aspect 22. The method of Aspect 21, wherein the epoxide resin is reaction of epichlorohydrin or epibromohydrin with a polyphenol.

Aspect 23. The method of Aspect 21, wherein the epoxide resin is a diglycidyl ether of bisphenol A or bisphenol F, a tetraglycidyl methylenedianiline, or a diglycidylaminophenyl glycidyl ether.

Aspect 24. The method of Aspect 18, wherein the second stoichiometrically offset thermoset polymer has a stoichiometric offset of from about 0.01 to about 0.20, wherein the stoichiometric offset is the molar equivalents of the hardener groups divided by the molar equivalents of the hardener reactive groups in the first stoichiometrically offset thermoset polymer.

Aspect 25. The method of Aspect 18, wherein the first stoichiometrically offset thermoset polymer comprises reinforcement fibers impregnated with the second stoichiometrically offset thermoset polymer.

Aspect 26. The method of Aspect 25, wherein the reinforcement fibers comprise carbon fibers, glass fibers, and/or para-aramid synthetic fiber.

Aspect 27. The method of Aspect 18, wherein step (b) consists of applying only the second stoichiometrically offset thermoset polymer to the first faying surface of the first composite substrate and the second composite substrate.

Aspect 28. The method of Aspect 18, wherein the first stoichiometrically offset thermoset polymer comprises an amine.

Aspect 29. The method of Aspect 18, wherein the first stoichiometrically offset thermoset polymer has a stoichiometric offset of about 1.50 to about 10.00, wherein the stoichiometric offset is the molar equivalents of the hardener groups divided by the molar equivalents of the hardener reactive groups in the second stoichiometrically offset thermoset polymer.

Aspect 30. The method of Aspect 18, wherein the first adhesive has a curing temperature of about 100° C. to about 400° C.

Aspect 31. The method of Aspect 18, wherein the first adhesive comprises a conventional resin.

Aspect 32. The method of Aspect 18, wherein the first adhesive is film or paste adhesive.

Aspect 33. The method of Aspect 18, wherein when the first adhesive is a film, the first adhesive is applied in an amount of 1 to 20 plies of adhesive film.

Aspect 34. The method of Aspect 18, wherein the method does not include surface preparation.

Aspect 35. A method for producing a composite comprising:
(a) providing a first composite substrate, wherein the first composite substrate comprises a substrate with a faying surface comprising a first curable resin comprising a first stoichiometrically offset thermoset polymer, wherein the first stoichiometrically offset thermoset polymer is stoichiometrically offset with hardener reactive groups, wherein the first curable resin has a second faying surface, and wherein the first composite substrate is cured;
(b) providing a second composite substrate, wherein the second composite substrate comprises a substrate comprising a first faying surface
(c) applying a second stoichiometrically offset thermoset polymer to the second faying surface of the first composite substrate, wherein second stoichiometrically offset thermoset polymer is stoichiometrically offset with hardener groups to produce a first stack, and
   wherein the molar ratio of the hardener reactive groups of the first stoichiometrically offset thermoset polymer and the hardener groups of the second stoichiometrically offset thermoset polymer is from about 0.6 to about 1.2 after cure;
(d) coupling the first stack with the second composite substrate, wherein the second stoichiometrically offset thermoset polymer is in contact with the first faying surface of the second composite substrate to produce a second stack; and
(e) curing the second stack to produce the composite.

Aspect 36. The method of Aspect 35, wherein the first composite substrate and the second composite substrate comprises reinforcement fibers impregnated with the first curable resin.

Aspect 37. The method of Aspect 36, wherein the reinforcement fibers comprise carbon fibers, glass fibers, and/or para-aramid synthetic fiber.

Aspect 38. The method of Aspect 35, wherein the first stoichiometrically offset thermoset polymer comprises an epoxide resin, a bismaleimides resin, or an isocyanate resin.

Aspect 39. The method of Aspect 38, wherein the epoxide resin is reaction of epichlorohydrin or epibromohydrin with a polyphenol.

Aspect 40. The method of Aspect 38, wherein the epoxide resin is a diglycidyl ether of bisphenol A or bisphenol F, a tetraglycidyl methylenedianiline, or a diglycidylaminophenyl glycidyl ether.

Aspect 41. The method of Aspect 35, wherein the first stoichiometrically offset thermoset polymer has a stoichiometric offset of from about 0.01 to about 0.20, wherein the stoichiometric offset is the molar equivalents of the hardener groups divided by the molar equivalents of the hardener reactive groups in the first stoichiometrically offset thermoset polymer.

Aspect 42. The method of Aspect 35, wherein the second stoichiometrically offset thermoset polymer comprises reinforcement fibers impregnated with the second stoichiometrically offset thermoset polymer.

Aspect 43. The method of Aspect 42, wherein the reinforcement fibers comprise carbon fibers, glass fibers, and/or para-aramid synthetic fiber.

Aspect 44. The method of Aspect 35, wherein step (b) consists of applying only the second stoichiometrically offset thermoset polymer to the first faying surface of the first composite substrate and the second composite substrate.

Aspect 45. The method of Aspect 35, wherein the second stoichiometrically offset thermoset polymer comprises an amine.

Aspect 46. The method of Aspect 35, wherein the second stoichiometrically offset thermoset polymer has a stoichiometric offset of about 1.50 to about 10.00, wherein the stoichiometric offset is the molar equivalents of the hardener groups divided by the molar equivalents of the hardener reactive groups in the second stoichiometrically offset thermoset polymer.

Aspect 47. The method of Aspect 35, wherein the method does not include surface preparation.

### Examples

The following examples are put forth so as to provide those of ordinary skill in the art with a complete disclosure and description of how the compounds, compositions, articles, devices and/or methods claimed herein are made and evaluated, and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure.

### Materials

Epoxy resins (i.e., HRG) were formulated using API-60® (part A) epoxy resin supplied by Kaneka North America® with an epoxy equivalent weight of 131 g/mol and diethyltoluenediamine (DETDA, part B) hardener supplied by Alpha Chemistry® with a hardener equivalent weight of 44.6 g/mol. Epoxy rich (i.e., HRG) resin, conventional ratio (CR) resin, and hardener rich (i.e., HG) resin was formulated from part A and part B. The HRG, CR, and HG resins had initial stoichiometric offsets of r=0.1, r=0.8, and r=2.5 where r is defined in [Eq. (1)].

$$r = \frac{{eq}_{H}}{{eq}_{E}} ≡ \frac{molar equivalents of hardener}{molar equivalents of epoxy} \qquad ( 1 )$$

Prior research utilizing rheology and calorimetry indicated that an HRG r-value less than or equal to 0.15 effectively inhibited gelation during the primary cure. An HRG r-value of 0.1 was chosen for optimal mechanical performance [5]. Unidirectional Hexcel® IM7/G 12K fiber was impregnated with the HRG, CR, and HG resins utilizing an in-house prepreg machine at NASA Langley Research Center. The composite panels were fabricated using Hexcel® HexPly® IM7G/8552, 190 g/m² fiber areal weight (FAW), 34 wt. % resin content, unidirectional prepreg as the conventional material. Solvay FM® 209-1U film adhesive was used in the bonding of the composite panels. Fluorinated ethylene propylene (FEP) film was incorporated during layup to create crack starters for mechanical testing.

### Composite Panel Fabrication

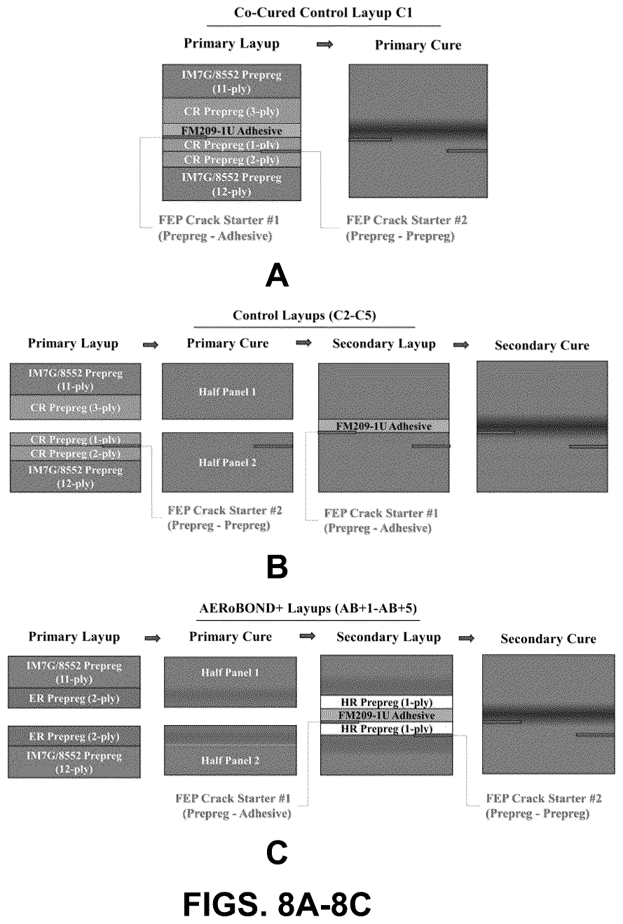

A total of ten composite panels were fabricated for testing. Within this set, five panels were designated as control panels, serving as a baseline for comparison, and denoted as C1, C2, C3, C4, and C5. The remaining five panels were fabricated using the AERoBOND+ method and are denoted as AB+1, AB+2, AB+3, AB+4, and AB+5. The material layup order for each panel is shown in FIG. 8.

Panels C2-C5 and panels AB+1-AB+5 underwent a two-step curing process. The first step was a primary cure cycle that produced two separate half panels as depicted in FIG. 8B and FIG. 8C. Industry standard vacuum bagging methods were used to fabricate each panel on a flat aluminum tool surface. Special considerations were taken to ensure optimal resin retention and surface texture for the use of offset resins. Because the offset resins are designed to not gel during the primary cure cycle, each half panel was enclosed in an impermeable envelope made using 50 μm thick FEP (Airtech, A4000V) release film and 25 mm wide medium-tack, flash breaker tape (Airtech, Flashbreaker® 1). Additionally, edge dams made from Airtech Airdam 1 tape were applied around the perimeters of all panels outside the FEP envelope to prevent resin bleed. The faying surface of each half panel (not applicable to Panel C1) was placed on the tool side (i.e., bottom of laminate stack) to achieve a smoother finish. Prior to sealing the bag (Airtech® Ipplon® DP1000) with vacuum, 5-mm thick steel caul plates, permeable release fabric (release ease), and a breather blanket (Airtech® Ultraweave® 1332) were placed over the part. After vacuum bagging, all panels underwent the following primary cure cycle in the autoclave: apply vacuum to vacuum bag (VB), heat to 107° C. (225° F.), apply 689 kPa gauge pressure (100 psig), hold for one hour, heat to 177° C. (350° F.), hold for two hours, cooldown. Panel C1 underwent this cure cycle while fully laid up as depicted in FIG. 8A resulting in a co-cured panel. The resulting C2-C5, and AB+1-AB+5 half panels then underwent a secondary layup prior to going through a secondary cure cycle resulting in secondary bonded panels. The secondary cure cycle for each panel and whether the half panels received surface preparation (SP) is detailed in Table 1. Surface preparation consisted of sanding on the faying surface prior to the secondary layup with 220 grit garnet until they were a uniform grey followed by repeated wiping of surface with tech wipes coated with isopropyl alcohol (IPA) until no residue present on new wipe.

TABLE 1
Panel Properties and Secondary Cure Cycle Processing Conditions.

| | Panel | | | | | | | | | |
|---|---|---|---|---|---|---|---|---|---|---|
| | C1 | C2 | C3 | C4 | C5 | AB + 1 | AB + 2 | AB + 3 | AB + 4 | AB + 5 |
| | Panel Properties | | | | | | | | | |
| Length (mm) | 305 | 305 | 305 | 305 | 305 | 305 | 305 | 305 | 305 | 305 |
| Width (mm) | 305 | 305 | 305 | 305 | 305 | 305 | 305 | 152 | 152 | 305 |
| Surface Prep (SP) | No | No | SP | SP | SP | No | No | No | SP | SP |
| | SP | SP | | | | SP | SP | SP | | |
| Bond Type | Co- | Sec. | Sec. | Sec. | Sec. | Sec. | Sec. | Sec. | Sec. | Sec. |
| | Cured | bond | bond | bond | bond | bond | bond | bond | bond | bond |
| | Primary Cure Cycle Processing Conditions | | | | | | | | | |
| Equipment (EQ) | Auto- | Auto- | Auto- | Auto- | Auto- | Auto- | Auto- | Auto- | Auto- | Auto- |
| | clave | clave | clave | clave | clave | clave | clave | clave | clave | clave |
| EQ Pressure | 689 | 689 | 689 | 689 | 689 | 689 | 689 | 689 | 689 | 689 |
| (kPa gauge) | | | | | | | | | | |
| VB Pressure | −101 | −101 | −101 | −101 | −101 | −101 | −101 | −101 | −101 | −101 |
| (kPa gauge) | | | | | | | | | | |
| Total Pressure (kPa) | 790 | 790 | 790 | 790 | 790 | 790 | 790 | 790 | 790 | 790 |
| Ramp Rate (° C./min) | 2.8 | 2.8 | 2.8 | 2.8 | 2.8 | 2.8 | 2.8 | 2.8 | 2.8 | 2.8 |
| Hold 1 (° C.) | 107 | 107 | 107 | 107 | 107 | 107 | 107 | 107 | 107 | 107 |
| Hold 1 (min) | 60 | 60 | 60 | 60 | 60 | 60 | 60 | 60 | 60 | 60 |
| Hold 2 (° C.) | 177 | 177 | 177 | 177 | 177 | 177 | 177 | 177 | 177 | 177 |
| Hold 2 (min) | 120 | 120 | 120 | 120 | 120 | 120 | 120 | 120 | 120 | 120 |
| | Secondary Cure Cycle Processing Conditions | | | | | | | | | |
| Equipment (EQ) | NA | Auto- | Press | Oven | Auto- | Press | Oven | Auto- | Oven | Auto- |
| | | clave | | | clave | | | clave | | clave |
| EQ Pressure | NA | 689 | 35 | 0 | 689 | 35 | 0 | 689 | 0 | 689 |
| (kPa guage) | | | | | | | | | | |
| VB Pressure | NA | −101 | NA | −101 | −101 | NA | −101 | −101 | −101 | −101 |
| (kPa guage) | | | | | | | | | | |
| Total Pressure (kPa) | NA | 790 | 35 | 101 | 790 | 35 | 101 | 790 | 101 | 790 |
| Ramp Rate (° C./min) | NA | 2.8 | 2.8 | 2.8 | 2.8 | 2.8 | 2.8 | 2.8 | 2.8 | 2.8 |
| Hold 1 (° C.) | NA | 107 | 107 | 107 | 107 | 107 | 107 | 107 | 107 | 107 |
| Hold 1 (min) | NA | 60 | 60 | 60 | 60 | 60 | 60 | 60 | 60 | 60 |
| Hold 2 (° C.) | NA | 177 | 177 | 177 | 177 | 177 | 177 | 177 | 177 | 177 |
| Hold 2 (min) | NA | 240 | 240 | 240 | 240 | 240 | 240 | 240 | 240 | 240 |

For each panel, two FEP crack starters were incorporated during the layup process for mechanical testing as indicated in FIG. 8. Crack starter #1 was positioned at the interface between the adhesive and the prepreg (adhesive to prepreg), while crack starter #2 was placed at the neighboring interface between the prepreg plies (prepreg to prepreg). These crack starters were 76.2 mm long in the fiber direction and spanned the width of each panel. The offset of one ply of the IM7G/8552 prepreg was deliberately employed to position the crack starters near the center of the panels' thickness for mechanical testing.

### Test Specimen Fabrication

Each panel was machined into two types of test specimens. The first type was for Double Cantilever Beam (DCB) and End-Notched Flexure (ENF) tests (i.e., interlaminar fracture toughness tests), while the second type was for Short Beam Strength (SBS) testing. The DCB/ENF test specimens were cut using a waterjet and were nominally 203 mm (8.0 in.) in length and 20 mm (0.8 in.) in width with fibers running along the direction of the length. Half of the DCB/ENF specimens from each panel contained a crack starter at the adhesive to prepreg interface and the remaining half contained a crack starter at the prepreg to prepreg interface. The SBS test specimens were cut using a wet saw with a diamond coated tip blade and were nominally 30.5 mm (1.20 in.) in length and 10.2 mm (0.40 in.) in width.

### Ultrasonic Inspection

A MISTRAS® UPK-T60-HS high-speed C-scan system, equipped with an NDT Automation® 10.0 MHz/13 mm immersion transducer (IU10G1), was utilized to conduct ultrasonic inspection in pulse-echo mode at a scan speed of 127 mm/s with a 0.5 mm×0.5 mm per pixel resolution. Each panel was ultrasonically inspected after the secondary cure (primary cure for panel C1) prior to being machined into test specimens. C-scan images were generated for each panel by evaluating the maximum ultrasonic amplitude from the joint line. Subsequently, the average amplitude value from the area between the crack starters was calculated using MATLAB®. Additionally, both DCB and ENF specimens were ultrasonically scanned after being waterjet cut, prior to testing. ENF specimens were scanned two more times during testing to ensure valid test results.

### Mechanical Testing

### Double Cantilever Beam

Double Cantilever beam (DCB) tests were conducted in accordance with ASTM 5528 to measure mode-I interlaminar fracture toughness. Following the curing process, each panel underwent ultrasonic scanning prior to and after being cut into test specimens. Each specimen's side edges were lightly polished to reduce out-of-plane stress concentrations (i.e., defects caused by the waterjet), which could lead to premature failures at the edges that can progress across the specimen.

For load introduction, aluminum piano hinge grips were bonded to the specimen arms using Loctite® EA 9395 two-part epoxy at ambient temperature. The specimen edges were spray painted white to facilitate crack visualization, and an adhesive measurement scale in millimeters was applied. Specimens were pin mounted to clevis hardware and loaded monotonically in displacement control at a rate of 0.51 mm/min. The loading profile included an initial load/unload segment intended to extend the crack tip approximately 1-3 mm beyond the inherent resin pocket that forms behind the FEP insert during curing. Then, the specimen was reloaded until the crack length reached approximately 50 mm, at which point unloading occurred. The fracture toughness values reported herein were obtained during the second loading phase, representing the lowest and most conservative values. Throughout the loading process, two 5-megapixel cameras equipped with 35 mm lenses were positioned on each painted side of the specimen, capturing images of the specimen edges every 3 seconds. The images allow each fracture toughness value (i.e., crack growth resistance) to be correlated with a specific crack length, resulting in a delamination growth resistance curve (R-curve).

### End-Notched Flexure

End-notched flexure (ENF) tests were conducted in accordance with ASTM D7905 to measure mode-II interlaminar fracture toughness. Each ENF test specimen received the same polishing as described previously for DCB testing.

Each ENF specimen underwent two testing procedures following the same methodology. In the first test, the delamination was initiated from a microscopically blunt crack tip formed by the FEP insert. Due to this bluntness, the stress concentration at the crack tip is lower compared to that of a sharp crack tip. Consequently, a greater crack driving force is required to propagate the delamination, leading to non-conservative fracture toughness values obtained from the first test. However, as the delamination progresses from the initial test, the crack tip naturally sharpens at the microscopic level, rendering it suitable for the subsequent test. Since the specimen is considered to have been previously cracked by the first test, the specimen for the second test is considered now to be precracked (PC), which retroactively defaults the specimen in the first test to be labeled non-precracked (NPC). Due to the inherent variability in the FEP fabricated crack tip, NPC test results generally exhibit higher fracture toughness values with greater variability, while PC tests tend to yield more consistent results with more conservative fracture toughness values.

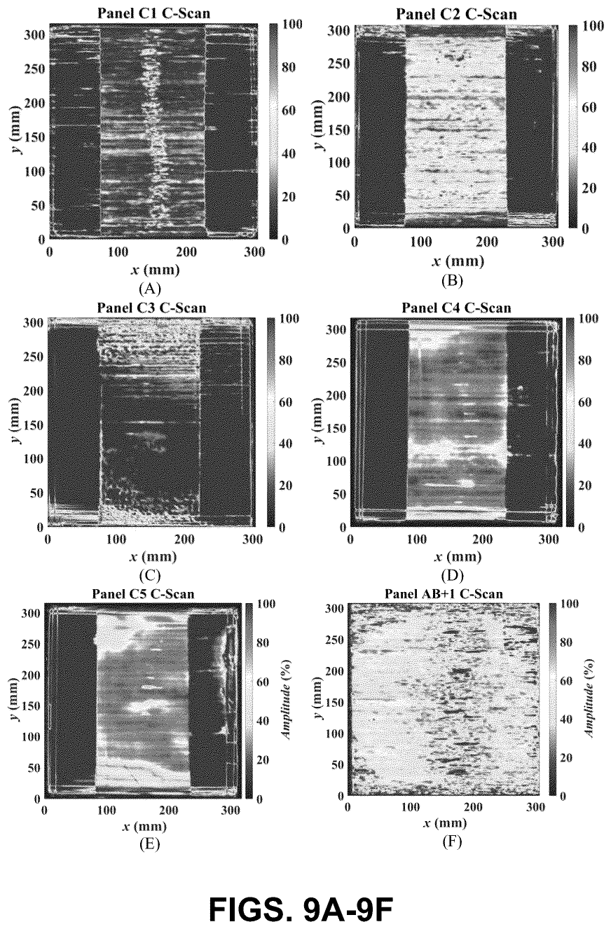

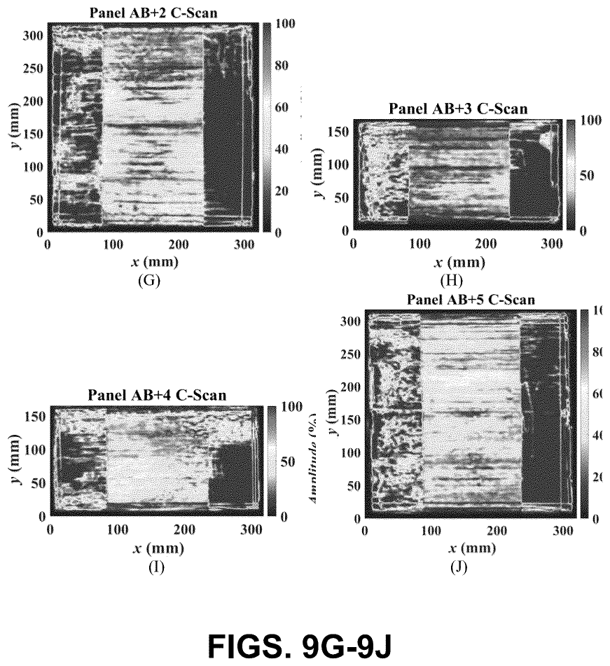

To ensure the integrity of the test results, each specimen underwent ultrasonic scanning after both NPC and PC tests, as depicted in FIG. 9. Invalid results were identified if the delamination migrated to another interface or if the crack front exhibited non-uniform growth. This validation process ensures the reliability and accuracy of the fracture toughness measurements.

### Short Beam Strength

SBS tests were conducted in accordance with ASTM D2344 to measure short beam strength.

### Results and Discussion

### Ultrasonic Inspection

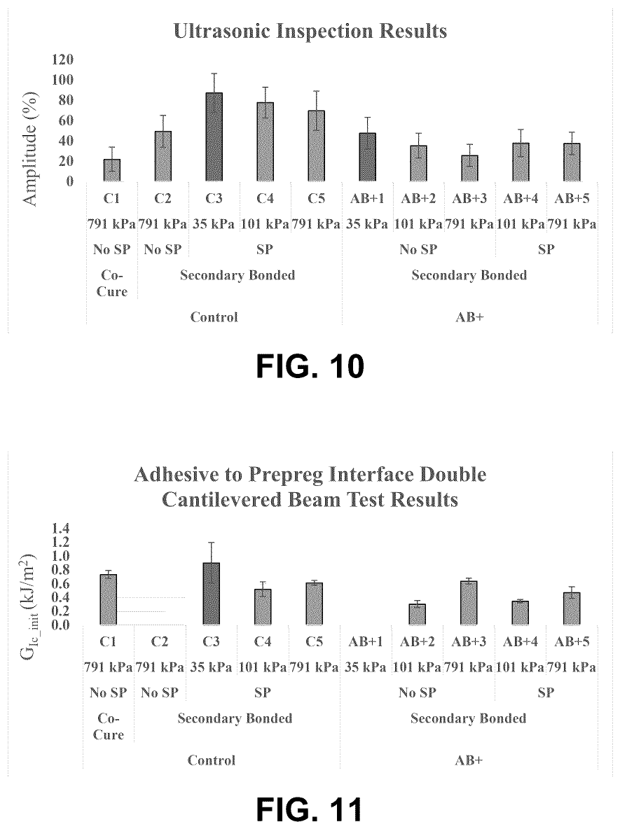

The ultrasonic inspection results of each panel are shown in FIG. 10. The highest amplitude signal reflected from the joint line was calculated for each location (i.e., pixel) of the panel and displayed as a C-scan image. These images can provide valuable insights into the material composition, revealing slight variations (weak acoustic reflections) or indicating the presence of voids, disbonds, or foreign debris (strong acoustic reflections). In this configuration, a higher ultrasonic amplitude at the joint line indicates more significant material property change at the joint (i.e., a lower amplitude is preferred). In each image (except for AB+1), the FEP crack starters were easily identifiable by their strong acoustic reflection and appear as two 76 mm wide dark red strips running the width of each side of every panel. For AB+1, the FEP crack starter was located below one of the HRG/HG and HG/adhesive interfaces, which shadowed the reflection from the FEP insert for this case. The average amplitude of every pixel located between the crack starters for each panel is graphed in FIG. 11. Based on the results, it can be observed that the co-cured Panel C1 exhibits the most favorable performance. Panel AB+3 shows a close comparison that falls within one standard deviation of Panel C1. A general trend of lower amplitude values can be observed in the AB+ panels as compared to the control panels indicating a reduced material property gradient at the joint line due to the reflow and mixing at each interface. Additionally, both the control and AB+ panels show a trend of decreasing amplitude with increased secondary cure pressure.

### Mechanical Testing

### Adhesive to Prepreg Interface

### Double Cantilever Beam

Mode-I interlaminar fracture toughness (G_{IC}) from the valid DCB tests for the adhesive to prepreg interface are reported in FIG. 11. As previously mentioned, the values reported are the fracture toughness at the initiation (init) of damage. The initiation values reported in this study were determined using the 5% slope-reduction method. This method involves measuring the slope of the loading profile in the linear “load-up” region, which represents the stiffness of the specimen. The load used for the calculation is obtained by reducing the measured slope by 5%. Results of panel C2 are missing as DCB tests were not conducted in the earliest phases of the research and all tests from AB+1 produced invalid results. The results from Panel AB+3 indicate that under the application of 689 kPa gauge pressure and vacuum bagging, the AB+ method demonstrates similar interlaminar fracture toughness compared to the co-cured joint (C1) as well as the secondary bonded joint with surface pressure and similar high pressure (C5). However, as the pressure decreases, the performance of the AB+ panels show a decline, whereas the control panels do not exhibit the same trend. The observed decrease in mechanical properties of the AB+ panels, particularly under reduced pressure, supports the idea that the HG prepreg may be experiencing inadequate pressures for bonding in the secondary cure due to the already cured half panels. To address this issue, a potential solution could involve replacing the hardener-rich prepreg with a hardener-rich adhesive layer which is designed for lower pressure cure cycles. By employing this method, it becomes possible to maintain the desired stoichiometric offset and promote mobility in the resin at the faying surface during the secondary cure. This mobility facilitates mass transfer and helps achieve a balanced resin stoichiometry even under low-pressure secondary cure cycles.

### End Notched Flexure

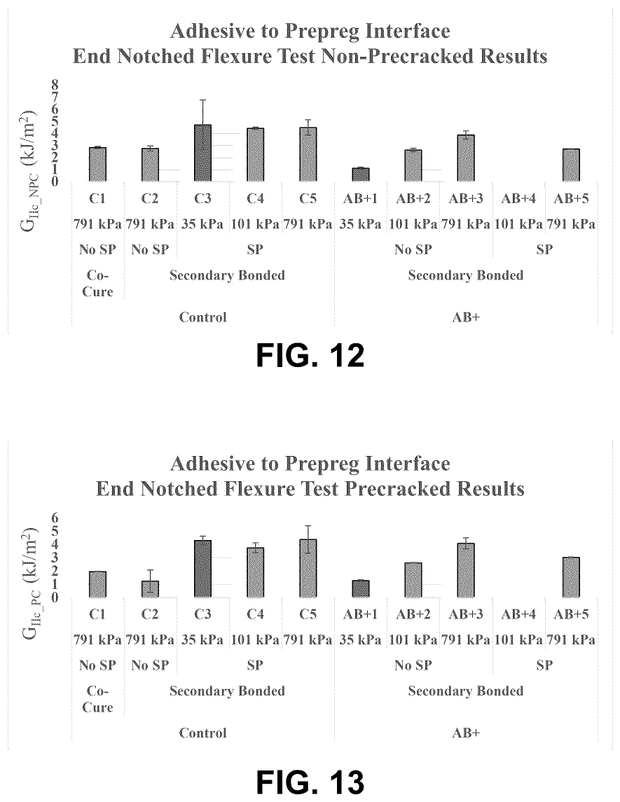

Mode-II fracture toughness from the NPC condition of valid ENF test specimens for the adhesive to prepreg interface is reported in FIG. 12. The subsequent valid ENF specimens in the PC condition, which is a more accurate representation of bond performance, is presented in FIG. 13. Results from panel AB+4 are missing due to lack of materials resulting in a half-sized panel and therefore no test specimens for ENF testing. Similar to the results observed in DCB testing, Panel AB+3 exhibits comparable mechanical properties to the control panels. Once again, a decrease in pressure during the secondary cure process in the AB+ panels lead to significantly lower mechanical properties, while the control panels appear to be unaffected by the reduction in pressure. As previously mentioned, the implementation of a hardener-rich adhesive layer instead of HG prepreg could serve as a potential solution to mitigate this issue. By using a hardener-rich adhesive, the challenges associated with reduced pressure during secondary cure could be addressed, leading to improved mechanical properties and performance of the AB+ panels.

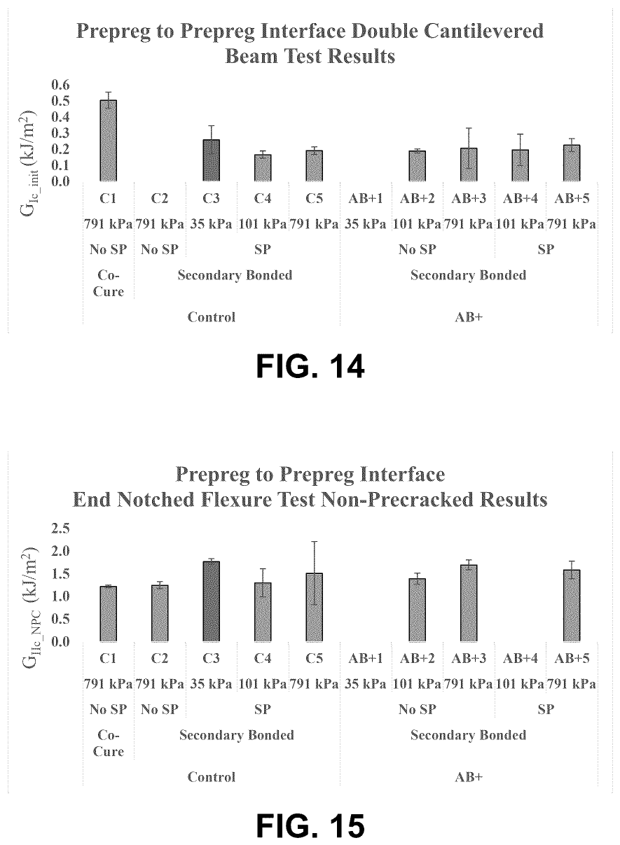

Of particular note was the poor performance of C2 (secondary bonded control panel without surface preparation) especially with respect to AB+3, which was bonded under identical conditions without surface preparation, see FIG. 14. The comparison of C2 to AB+3 as well as the comparison AB+3 (no surface preparation) with AB+5 (with surface preparation) highlights the insusceptibility of the AERoBOND+ method to contamination and the removal of the need for surface preparation that exists for conventional secondary bonded joints.

### Prepreg to Prepreg Interface

### Double Cantilevered Beam

Mode-I interlaminar fracture toughness (G_{IC}) from the valid DCB tests for the prepreg to prepreg interface are reported in FIG. 14. Results of panel C2 are missing as DCB tests were not conducted in the earliest phases of the research and AB+1 data is missing due to an improper layup resulting in no crack starter in the prepreg to prepreg interface. The same test procedure as described earlier for the adhesive to prepreg interface was also employed for DCB testing of the prepreg to prepreg interface.

### End Notched Flexure

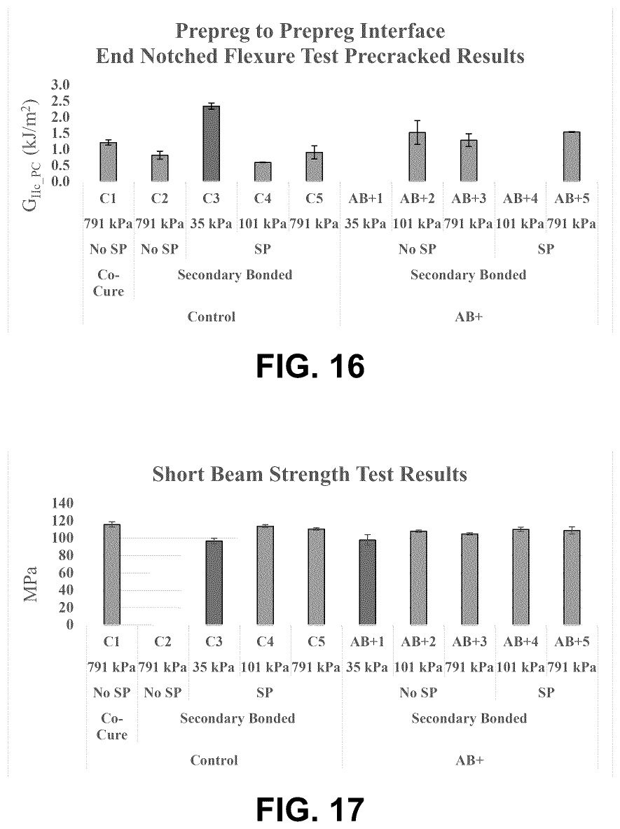

Mode-II fracture toughness from the NPC condition of valid ENF test specimens for the prepreg to prepreg interface is reported in FIG. 15. The subsequent valid ENF specimens in the PC condition is presented in FIG. 16. As mentioned, AB+1 data is missing due to an improper layup resulting in no crack starter in the prepreg to prepreg interface while AB+4 is missing data due to lack of material for a full panel and therefore no test specimens for ENF testing.

### Short Beam Strength

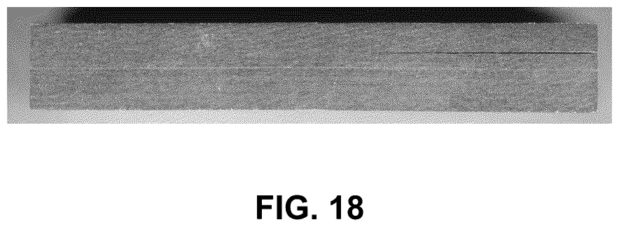

The average short beam strength of each panel is reported in FIG. 17. No SBS test were performed for panel C2 as the test was not included in the initial test plan. The results of the SBS tests revealed consistent failures at the IM7/8552 prepreg interface for all panels, as indicated by the data and confirmed by the observed failure in FIG. 18. This consistent failure pattern was observed across all tested panels. The obtained data suggests that both the adhesive to prepreg and prepreg to prepreg interfaces exhibit comparable or greater strength than the IM7/8552 prepreg interface in terms of short beam strength. However, direct comparison between the adhesive to prepreg and prepreg to prepreg interfaces cannot be made based on this data alone.

### SUMMARY

This work focused on evaluating the performance and bonding characteristics of the AERoBOND+ method under varying cure cycle parameters and preparations as compared to standard composite layups represented by varying control panels. DCB, ENF, and SBS tests were conducted to assess the mode-I and mode-II interlaminar fracture toughness and short beam strength of both the adhesive to prepreg interface and the prepreg to prepreg interface of each panel. The results revealed that AB+ panels, when subjected to higher bonding pressure during secondary cure, exhibited comparable mechanical properties to the control panels. However, reduced pressure during secondary cure in AB+ panels resulted in substantially lower mechanical properties, highlighting the importance of proper pressure application for achieving optimal bonding. Ultrasonic inspection of AB+ panels consistently revealed a reduced reflections from the joint due to reflow and mixing of the materials at each interface.

The implementation of a hardener-rich adhesive layer was proposed as a potential solution to address the issue of inadequate pressure in HG prepreg, which could allow for lower pressure secondary bonds using the AERoBOND+ method. The use of a hardener rich adhesive layer facilitates the retention of a stoichiometric offset and mobility in the faying surface resin during the secondary cure without the additional pressure needed to consolidate the HG prepreg.

The results reveal a noticeable trend of improved performance in the AB+ panels as the bonding pressure increases. Additionally, the results indicate that AB+ panels without the presence of surface preparation exhibit higher performance compared to those with SP. These findings suggest that higher bonding pressure and the absence of surface preparation contribute to enhanced performance in the AB+ panels.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

### REFERENCES

[1] G. Gardiner, “Certification of bonded composite primary structures”, Composites world 2014 Mar. 3. https://www.compositesworld.com/articles/certification-of-bonded-composite-primary-structures.
[2] D. W. Hempe, In: Administration USDoTFA, editor. Advisory circular number 20-107B., Washington, DC: US Department of Transportation; 2010. p. 1-38.
[3] V. Martinez-Landeros, S. Vargas-Islas, C. Cruz-Gonzalez, S. Barrera, K. Mourtazov and R. Ramirez-Bon, “Studies on the influence of surface treatment type, in the effectiveness of structural adhesive bonding, for carbon fiber reinforced composites,” Journal of Manufacturing Processes, vol. 39, pp. 160-166, 2019. https://doi.org/10.1016/j.jmapro.2019.02.014.
[4] F. Palmieri, T. Hudson, A. Smith, R. Cano, Y. Lin and J. Kang, “Latent cure epoxy resins for reliable joints in secondary-bonded composite structures,” Composites Part B, 2022, https://doi.org/10.1016/j.compositesb.2021.109603.
[5] A. Smith, J. Salem, T. Hudson and F. Palmieri, “Interlaminar mechanical performance of latent-cure epoxy joints,” Composites Part B, 2023, https://doi.org/10.1016/j.compositesb.2023.110567.
[6] T. Hudson, F. Baro, A. Smith, J. Kang, R. Cano and F. Palmieri, “Ultrasonic Inspection During Autoclave Cure of Reflowable-Interface Composite Joints,” Journal of Composite Materials, 2023.
[7] F. Palmieri, T. Hudson, R. Cano, E. Tastepe, D. Rufeisen and L. Ahmed, Adhesive joining of composite laminates using epoxy resins with stoichiometric offset, Hilton Head, SC, Annual meeting of the Adhesion Society; 2019.
[8] F. Palmieri, T. Hudson, R. Cano, E. Tastepe, D. Rufeisen and L. Ahmed, Reliable bonding of composite laminates using reflowable epoxy resins, In: 2019 meeting of the society for the advancement of materials and process engineering. Charlotee, NC, SAMPE; 2019.
[9] F. Palmieri, T. Hudson, A. Smith, R. Cano, Y. Lin and J. Kang, Modified epoxy matrix resins for reduced dependence on redundant fasteners in secondary-bonded composite structures, In: 2020 annual meeting of the society for the advancement of materials and process engineering. Seattle, WA., SAMPE; 2020.
[10] F. Palmieri, T. Hudson, A. Smith, R. Cano, Y. Lin and J. Kang, Reduced dependnce on reduntant fasteners in secondary-bonded composite structures using modified epoxy resins, In: 2020 Annual meeting of the Adhesion Society. Charleston, SC; 2020.
[11] ASTM Standard D5528-13, 1994 2013. Standard test method for mode I interlaminar fracture toughness of unidirectional fiber reinforced polymer matrix composites, West Conshohocken, PA: ASTM International, 2013, https://doi.org/10.1520/D5528-13.
[12] ASTM Standard D7905-14, 2019. Standard test method for mode II interlaminar fracture toughness of unidirectional fiber-reinforced polymer matrix composites, West Conshohocken, PA: ASTM International, 2014. https://doi.org/10.1520/.
[13] ASTM Standard D2344-16, Standard test method for short-beam strength of polymer matrix composite materials and their laminates, West Conshohocken, PA: ASTM International, 2000. DOI: 10.1520/D2344 D2344M-16.

What is claimed is:

1. A method for producing a composite comprising:
(a) providing a first composite substrate and a second composite substrate, wherein the first composite substrate and the second composite substrate each comprises a substrate with a faying surface comprising a first curable resin comprising a first stoichiometrically offset thermoset polymer, wherein the first stoichiometrically offset thermoset polymer is stoichiometrically offset with hardener reactive groups;
wherein the first composite substrate and/or the second composite substrate are cured such that hardener reactive groups remain on the faying surface of the composite substrate after cure;
(b) applying a second stoichiometrically offset thermoset polymer to the faying surface of the first composite substrate and the second composite substrate to produce a first stack and a second stack, wherein the second stoichiometrically offset thermoset polymer is stoichiometrically offset with hardener groups, and
wherein the molar ratio of the hardener reactive groups of the first stoichiometrically offset thermoset polymer and the hardener groups of the second stoichiometrically offset thermoset polymer is from about 0.6 to about 1.2 after cure;
(c) applying a first adhesive to the faying surface of the first stack, the faying surface of the second stack, or on both the faying surface of the first stack and the faying surface of the second stack to produce a third stack and fourth stack, wherein the first adhesive has a curing temperature within 25° C. of the curing temperature of the first curable resin on the first composite substrate and a second composite substrate;
(d) coupling the third stack with the fourth stack, wherein the first adhesive is between the second stoichiometrically offset thermoset polymer on the third stack and the fourth stack to produce a fifth stack; and
(e) curing the fifth stack to produce the composite.

2. The method of claim 1, wherein the first composite substrate and the second composite substrate comprises reinforcement fibers impregnated with the first curable resin.

3. The method of claim 2, wherein the reinforcement fibers comprise carbon fibers, glass fibers, and/or para-aramid synthetic fiber.

4. The method of claim 1, wherein the first stoichiometrically offset thermoset polymer comprises an epoxide resin, a bismaleimides resin, or an isocyanate resin.

5. The method of claim 4, wherein the epoxide resin is reaction of epichlorohydrin or epibromohydrin with a polyphenol.

6. The method of claim 4, wherein the epoxide resin is a diglycidyl ether of bisphenol A or bisphenol F, a tetraglycidyl methylenedianiline, or a diglycidylaminophenyl glycidyl ether.

7. The method of claim 1, wherein the first stoichiometrically offset thermoset polymer has a stoichiometric offset of from about 0.01 to about 0.20, wherein the stoichiometric offset is the molar equivalents of the hardener groups divided by the molar equivalents of the hardener reactive groups in the first stoichiometrically offset thermoset polymer.

8. The method of claim 1, wherein the second stoichiometrically offset thermoset polymer comprises reinforcement fibers impregnated with the second stoichiometrically offset thermoset polymer.

9. The method of claim 8, wherein the reinforcement fibers comprise carbon fibers, glass fibers, and/or para-aramid synthetic fiber.

10. The method of claim 1, wherein step (b) comprises applying only the second stoichiometrically offset thermoset polymer to the first faying surface of the first composite substrate and the second composite substrate.

11. The method of claim 1, wherein the second stoichiometrically offset thermoset polymer comprises an amine.

12. The method of claim 1, wherein the second stoichiometrically offset thermoset polymer has a stoichiometric offset of about 1.50 to about 10.00, wherein the stoichiometric offset is the molar equivalents of the hardener groups divided by the molar equivalents of the hardener reactive groups in the second stoichiometrically offset thermoset polymer.

13. The method of claim 1, wherein the first adhesive has a curing temperature of about 100° C. to about 400° C.

14. The method of claim 1, wherein the first adhesive comprises a conventional resin.

15. The method of claim 1, wherein the first adhesive is film or paste adhesive.

16. The method of claim 1, wherein when the first adhesive is a film, the first adhesive is applied in an amount of 1 to 20 plies of adhesive film.

17. The method of claim 1, wherein the method does not include surface preparation.

18. A method for producing a composite comprising:
(a) providing a first composite substrate and a second composite substrate, wherein the first composite substrate and the second composite substrate each comprises a substrate with a faying surface comprising a first curable resin comprising a first stoichiometrically offset thermoset polymer, wherein the first stoichiometrically offset thermoset polymer is stoichiometrically offset with hardener groups;
wherein the first composite substrate and/or the second composite substrate are cured such that hardener groups remain on the faying surface of the composite substrate after cure;
(b) applying a second stoichiometrically offset thermoset polymer to the faying surface of the first composite substrate and the second composite substrate to produce a first stack and a second stack, wherein the second stoichiometrically offset thermoset polymer is stoichiometrically offset with hardener reactive groups, and
wherein the molar ratio of the hardener groups of the first stoichiometrically offset thermoset polymer and the hardener reactive groups of the second stoichiometrically offset thermoset polymer is from about 0.6 to about 1.2 after cure;
(c) applying a first adhesive to the third faying surface of the first stack, the third faying surface of the second stack, or on both the third faying surface of the first stack and the third first faying surface of the second stack to produce a third stack and fourth stack, wherein the first adhesive has a curing temperature within 25° C. of the curing temperature of the first curable resin on the first composite substrate and a second composite substrate;
(d) coupling the third stack with the fourth stack, wherein the first adhesive is between the second stoichiometrically offset thermoset polymer on the third stack and the fourth stack to produce a fifth stack; and
(e) curing the fifth stack to produce the composite.

19. A method for producing a composite comprising:
(a) providing a first composite substrate, wherein the first composite substrate comprises a substrate with a faying surface comprising a first curable resin comprising a first stoichiometrically offset thermoset polymer, wherein the first stoichiometrically offset thermoset polymer is stoichiometrically offset with hardener reactive groups, wherein the first curable resin has a second faying surface, and wherein the first composite substrate is cured;
(b) providing a second composite substrate, wherein the second composite substrate comprises a substrate comprising a first faying surface
(c) applying a second stoichiometrically offset thermoset polymer to the second faying surface of the first composite substrate, wherein second stoichiometrically offset thermoset polymer is stoichiometrically offset with hardener groups to produce a first stack, and
wherein the molar ratio of the hardener reactive groups of the first stoichiometrically offset thermoset polymer and the hardener groups of the second stoichiometrically offset thermoset polymer is from about 0.6 to about 1.2 after cure;
(d) coupling the first stack with the second composite substrate, wherein the second stoichiometrically offset thermoset polymer is in contact with the first faying surface of the second composite substrate to produce a second stack; and
(e) curing the second stack to produce the composite.
